(19) United States
(12) Patent Application Publication
(10) Pub. No.: US 2012/0179618 A1
(43) Pub. Date: Jul. 12, 2012

(54) METHODS AND SYSTEMS FOR IMPROVING K-12 EDUCATION

(76) Inventors: Furman W. BROWN, Lakewood, CO (US); Jonathan Bruce Spear, Brooklyn, NY (US)

(21) Appl. No.: 13/206,037

(22) Filed: Aug. 9, 2011

Related U.S. Application Data
(60) Provisional application No. 61/371,900, filed on Aug. 9, 2010.

(51) Int. Cl. G06Q 50/20

(52) U.S. Cl. 705/327

(57) ABSTRACT

The educational model according to aspects of the present invention reengineers fundamental structures of education and provides rigorous, standards-driven, small-group instruction continuously for every student within a school system. The, model uses resources including time, talent and technology more efficiently to achieve better outcomes for faculty and students and systems of schools, and allows teachers more time with fewer students, increases the instructional year for students without increasing the work year for teachers, adding roughly 30% more instructional time for students without increasing the work year for teachers, and in fact includes more than 20 days of professional development into the teachers' regular work year. The model operates to improve education without increasing costs.

This application claims the benefit of U.S. Provisional Application No. 61/371,900 filed on Aug. 9, 2010, titled “METHODS AND SYSTEMS FOR IMPROVING K-12 EDUCATION,” which is incorporated by reference herein in its entirety.

### BACKGROUND OF THE INVENTION

1. Field of Invention

Aspects of the present invention relate to methods and systems for improving K-12 education. In particular, aspects of the present invention relate to methods and systems to use resources including time, talent, technology, and space more efficiently, achieve better outcomes for faculty and students and comprehensively or systematically address the needs of systems of schools.

2. Description of Related Art

Despite decades of reform efforts targeting changes in curricula, pedagogy, student groupings and instructional time, far fewer than half of public school students today read at levels “at or above proficient,” according to data from the U.S. Department of Education. Math proficiency is similarly low. For example, there is a significant achievement gap between students based on their respective socio-economic backgrounds. Statistics for urban schools are even more troubling. In general, few students are prepared for academic success beyond high school. In spite of these results, the basic organizational structures of public schools have not changed. Overwhelmingly, instruction still occurs in a roomful of students taught by a single teacher. As student populations grow more diverse, particularly in densely populated metropolitan areas, the challenge for one teacher to address each student's learning needs increases.

Most teachers today still work in an outdated mode and model. Teachers work in isolation, rarely collaborating with colleagues during the day. They often have fewer than 5 days of professional development over the course of a year. Teachers in middle and high schools typically teach five classes a day with more than 30 or even 35 students in classes with a total of 175 students each day. First year teachers and veterans have the same responsibilities; if anything, because of conventional seniority rules, teachers with less experience than others often have more difficult responsibilities.

According to the National Commission on Teaching and America's Future, nearly half of new teachers leave by their fifth year. In urban settings, the figures are much worse. Students enrolled in many big-city schools are exposed annually to inexperienced teachers who often struggle to manage a classroom and/or curricula, pedagogy and assessment. Resources invested by school districts and universities to train and support these new teachers bear little fruit and must be re-invested when young teachers leave the field prematurely.

Conventional school systems have grown and been reformed many times over time. With each wave of reform, new responsibilities are added to the system and new initiatives are added to the conventional school program. However, over time, the system is more responsive and reactive than pro-active, the initiatives compete with each other, and the system becomes less nimble. In addition, it has become increasingly difficult for systems to support schools and the professionals working in the school and to hold them meaningfully accountable. Current attention focuses simultaneously on the need for students to have more time in school, for schools to provide for a wider range of academic, social and emotional needs, and for teachers to have professional time. Most solutions proposed are piece-meal, attempting to solve one of the problems. Or they are not scalable or sustainable financially.

### SUMMARY OF THE INVENTION

In light of the above-described problems and unmet needs, aspects of the current invention provide a comprehensive re-design of organizational operation of a school in order to address effectively the learning needs of a diverse school community in addressing the above-discussed issues. These objectives may be achieved by relying upon a framework that enables talented people to serve useful roles in the school community by re-organizing resources including time, talent, technology and space. Aspects of the current invention reorganize the school day for the students and for the teachers, and also reorganize the school year to provide more education time for the students without substantially, if at all, increasing the work year of teachers.

Aspects of the current invention provide an environment that attracts talent into the teaching profession, keep new teachers who are good performers in the profession longer by, among other things, offering a more sensible entry into the field and a more professional and sustainable work place for staff over time. For example, aspects of the current invention provide teachers with more teaching time with fewer students, and with more professional time with other teachers. Aspects of the current invention render the teaching profession more attractive to highly performing college graduates, and create a pool of highly qualified teachers for urban public schools at large. In addition, aspects of current invention provide more than a week of professional time before the beginning of a new school year for both new and returning teachers to be more fully acclimated to the culture and expectations as the school. The professional time may also be used to gather and develop staff and refine expectations. For example, instead of placing a first year teacher in a classroom on their first day with the same responsibilities and expectations of a seasoned veteran, aspects of the current invention provide an opportunity for new teachers to practice several vital yet sensible roles in the school as they learn to become a skilled and confident teacher.

Aspects of the current invention create a positive model and a highly satisfying workplace for teachers, where teachers may have more teaching time with fewer students and, for example, more than an hour of collaborative time with other teachers every day. Teachers may also have a number of days of high quality professional development every year such as, for example, more than 20 days, and class sizes averaging 14-20 students in core courses.

Aspects of the current invention provide for a more robust staff for the school and create opportunities for the principal (lead administrator) to differentiate and distribute leadership and support staff. Aspects of this invention also include several types of courses such as, for example, Foundation courses. Other aspects of the invention include, but are not limited to, Foundation, Studio, and Intensive courses. Advantages of aspects of the current invention include taking into consideration a plurality of aspects, such as, for example, the academic, social, emotional, creative and physical needs of students, the professional needs of teachers by providing accountability needs of the system, partnership needs of families and the community, human resource needs of the school, and technology needs of the staff.

Aspects of the current invention provide a community where each child thrives academically, socially, emotionally, physically and creatively, by reorganizing the school day and the school year. For example, the school schedule may be reorganized by dividing the school day into a morning section, during which students take Foundation courses, and an afternoon section, during which students take Studio courses.

According to various aspects of the current invention, the Foundation courses may be the core of the instructional program. Foundation courses may be between 85 and 100 minutes long each, and may be taught by a team of teachers. In a fully scaled school, classes may average less than 20 students. The teams of teachers may include experts in the content area and/or experts in special needs or English Language Learner (ELL) instruction. Each team may teach their Foundation courses in the morning and may have common preparation time every day as a “daily debrief.” The daily debrief enables the staff to, for example, review the instructional goals, assess students' progress and plan. The shared work time may allow teachers to integrate critical data analysis into planning. Foundation courses may be core courses about, for example, mathematics, science, social studies and English language arts. In middle and high school, the sequence of Foundation courses prepare students for the major city and state exams they must pass to graduate high school.

According to various aspects of the current invention, every student may also attend three or four Studio courses daily, where each Studio course may last 60-72 minutes long. These courses are additional required courses, electives or mandated services. Courses may include such diverse offerings as arts and music, foreign language, fitness, advanced sciences and technology, targeted intervention, remediation or enrichment, and counseling. Each Studio course may last six to eight weeks. This length of time may allow students to take many types of courses throughout the year; it also enables the staff to plan courses that adapt to student needs and interests. For many students, youth development and enrichment programs may be what motivates them to stay in school. These types of courses are particularly important for students who are at risk of dropping out. By having most of the faculty strategically serve dual roles—teaching Foundation as well as Studio courses—the schools can offer a much wider variety of courses than a conventional school of the same size.

In addition, twice a year for a month at a time for example, all students may participate in rigorous, credit-bearing Intensive Courses modeled after intersession programs at universities. The Intensive Courses may provide opportunities for students to delve deeply into academic subjects and/or projects that connect them to their community or to a favorite subject. At the high school level, the Intensive Courses fundamentally transform the concept of college guidance, preparing students with the academic skills and knowledge they need to be accepted into post-secondary education, and the life skills and experiences to succeed once there.

The school year may also be reorganized by staggering teachers' vacation time in order to provide additional instructional days to students and additional professional development days for teachers without increasing the work year for teachers. The school year may also be reorganized to provide training periods for the teachers during the periods their students receive Intensive Courses. In Foundation, Studio and Intensive courses, students are engaged in active learning. They have significantly increased opportunities to engage actively with curriculum that is appropriate and relevant, in small groups, and with their teachers.

Aspects of the current invention provide professional staff significantly more professional time to work with colleagues or engage in professional development led by colleagues, the administration or partners by reconfiguring both the school day and the school year. By reconfiguring the school day, teachers may have more time each day with their content team and grade-level team. By reconfiguring teachers' work year, grade-level teams of teachers have more professional development time before the school year begins and during student vacations. The staff therefore has more opportunities to be proactive, outcome oriented, and dedicated to the achievement of their students. They can work more collaboratively, to adapt continuously to students' needs.

Aspects of the current invention include the potential for an innovative teacher training and induction program. Exceptional aspiring teachers may work side-by-side with skilled and experienced educators as they become confident and competent teachers themselves. Residents would receive extensive, on-site, practical training and support as they work to earn a degree in teaching. The residents may support the faculty in core Foundation courses, and may teach a Studio course to one or more small groups of students. A resident might also serve as part of a team with Intensives Teachers.

Aspects of the invention provide successful teachers with the opportunity to serve administrative residencies. For example, the successful teachers may continue to serve as teachers in the school and receive additional training and support during their mid-year breaks, during the grade- and school-level conferences, or during the summer. The teachers may pursue a degree or credential in collaboration with a university partner or other certified institution, and may begin to take on some of the responsibilities of a school based administrator while teaching a Foundation, Studio or Intensive course.

Aspects of the current invention provide teachers the opportunity to reconfigure curriculum as they prepare students for exit requirements and state mandated tests. Teachers with different expertise and credentials may collaborate to develop, teach and refine integrated curriculum such as, for example, a community study, Global Humanities, or an integrated math and science course. Teachers, as part of an interdisciplinary team, are able to teach small groups or combine small groups when most appropriate. They can use their time every day and during the year to support the development and refinement of curriculum and their pedagogy.

Aspects of the current invention allow for the staff of one school, who might, by virtue of the invention's use of time, have their school break at different times during the year, to use this time to provide guidance, oversight, and professional development at another school. Accordingly, schools and networks of similar schools may be able to share teaching resources and provide accountability in new and novel ways.

According to various aspects of the current invention, staff roles and responsibilities may be reconfigured to better align with the talent pool including high performing college students and high performing professionals in the field. Aspects of the invention allows for the use of a variety of recruitment tools including personal contacts, phone interviews and online surveys developed to screen for applicants to select candidates aligned with the values deemed most important to ensure the success of staff. The invention also allows for new teachers to receive professional support as they enter the profession and/or as they begin working at a school.

Additional advantages and novel features of the above aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 is an organizational chart illustrating a method of improving K-12 education, according to various aspects of the current invention;

FIG. 2 is a chart illustrating a classification of Foundation courses and Studio courses, according to various aspects of the current invention;

FIG. 3 is a chart illustrating a schedule of Foundation courses and Studio courses, according to various aspects of the current invention;

FIGS. 4A and 4B are charts illustrating an annual schedule for improving the school year, according to various aspects of the current invention;

FIG. 5 is a table illustrating a curriculum framework, according to various aspects of the current invention;

FIG. 6 presents an exemplary system diagram of various hardware components and other features, for use in accordance with an aspect of the present invention; and

FIG. 7 is a block diagram of various exemplary system components, in accordance with an aspect of the present invention.

### DETAILED DESCRIPTION OF PREFERRED ASPECTS

These and other features and advantages of this invention are described in, or are apparent from, the following detailed description of various exemplary aspects.

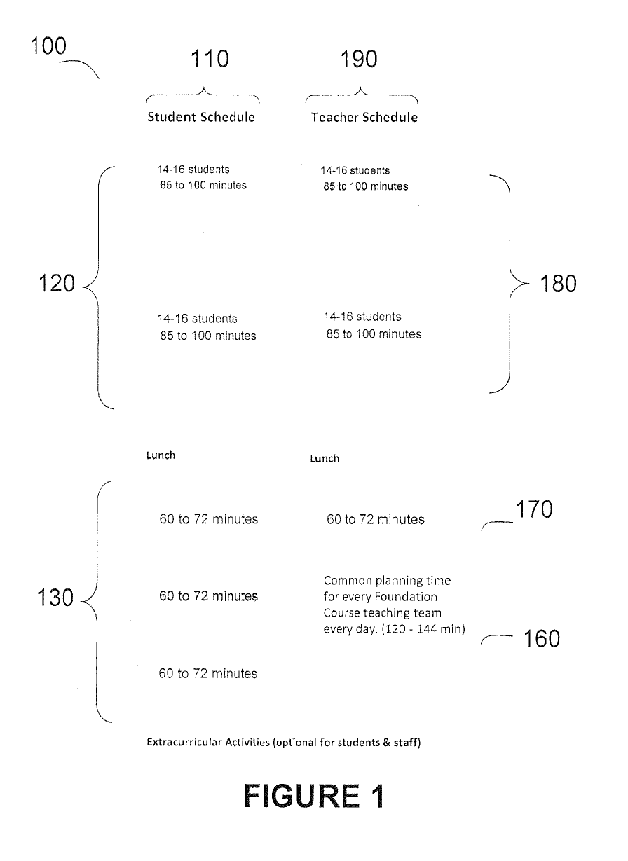

FIG. 1 is an organizational chart illustrating a method of improving K-12 education, according to various aspects of the current invention. In FIG. 1, the chart 100 organizes the schedules of teachers and students into two categories: Student Schedule 110 and Teacher Schedule 190. According to various aspects of the current invention, the student schedule 110 may include morning courses 120 and afternoon courses 130. The morning courses 120 may include, for example, two Foundation courses including classes such as Humanities and Integrated Math. The afternoon courses 130 may include a plurality of Studio courses such as, for example three Studio courses. According to various aspects, the Studio courses may include various courses such as Sciences, Math, World Languages, and the like. According to various aspects of the current invention, the teachers teaching Foundation courses and Studio courses may be the same. Alternatively, the teachers teaching Foundation courses and the teachers teaching Studio courses may be different. For example, during a single day, a Foundation course Teacher may teach one or two Foundation courses in the morning, and then one or more Studio courses in the afternoon.

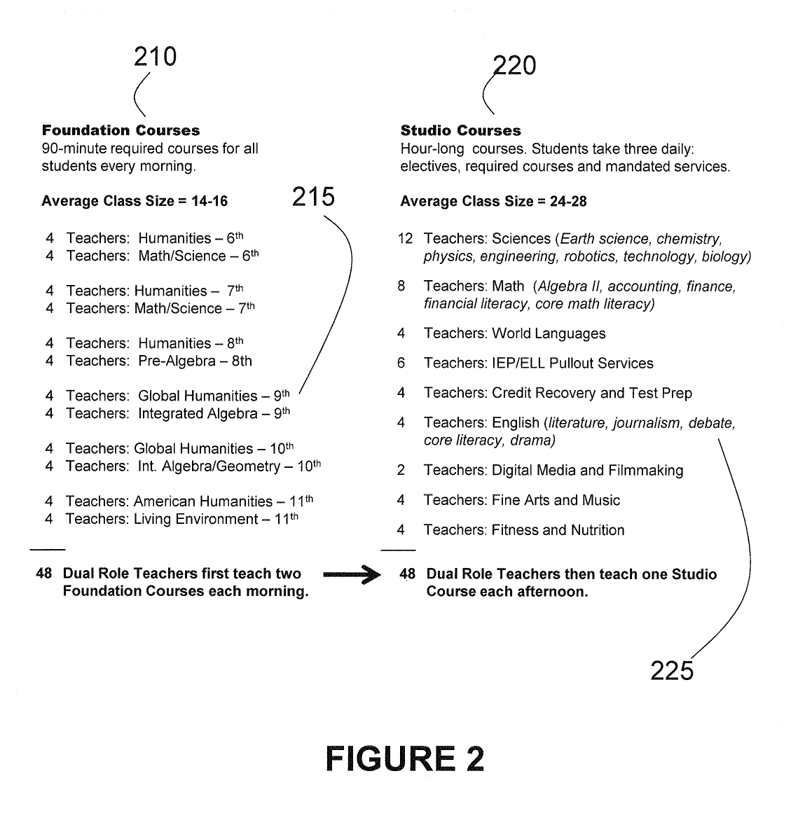

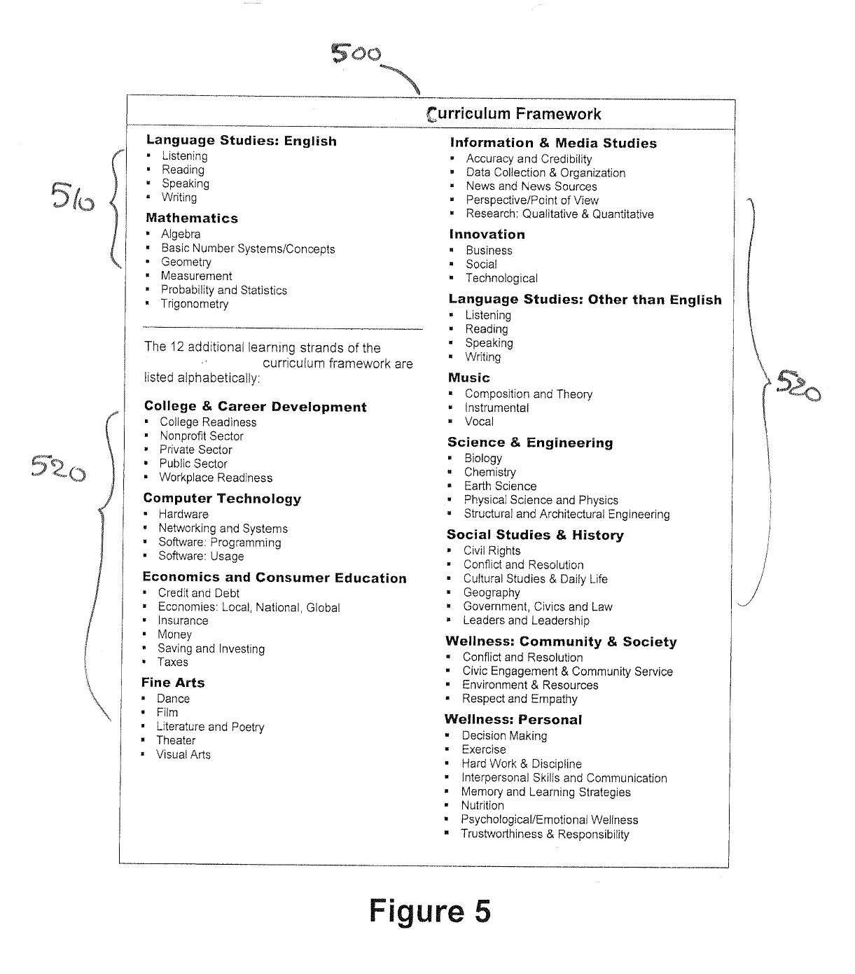

FIG. 2 illustrates a variety of Foundation courses 210 and Studio courses 220. In a fully scaled school, every student may attend three or four Studio courses 220 daily, each lasting about 60 to about 72 minutes long. According to various aspects, Studio courses 220 may be additional required courses, elective courses, or mandated services, and may be selected specifically to student grade, as illustrated by the list of courses 225. For scores of students nationwide, youth development and enrichment programs are generally what motivates them to stay in school. These types of Studio courses 220 may also important for students who are at risk for dropping out. Foundation courses 210 may also be selected specifically to student grade, as illustrated by the list of courses 215. By having the faculty strategically serve dual roles and teaching, for example, Foundation courses 210 as well as Studio courses 220, the school is able to offer a much wider variety of courses than a conventional school of the same size. FIG. 5 is a chart illustrating a curriculum framework, according to various aspects of the current invention.

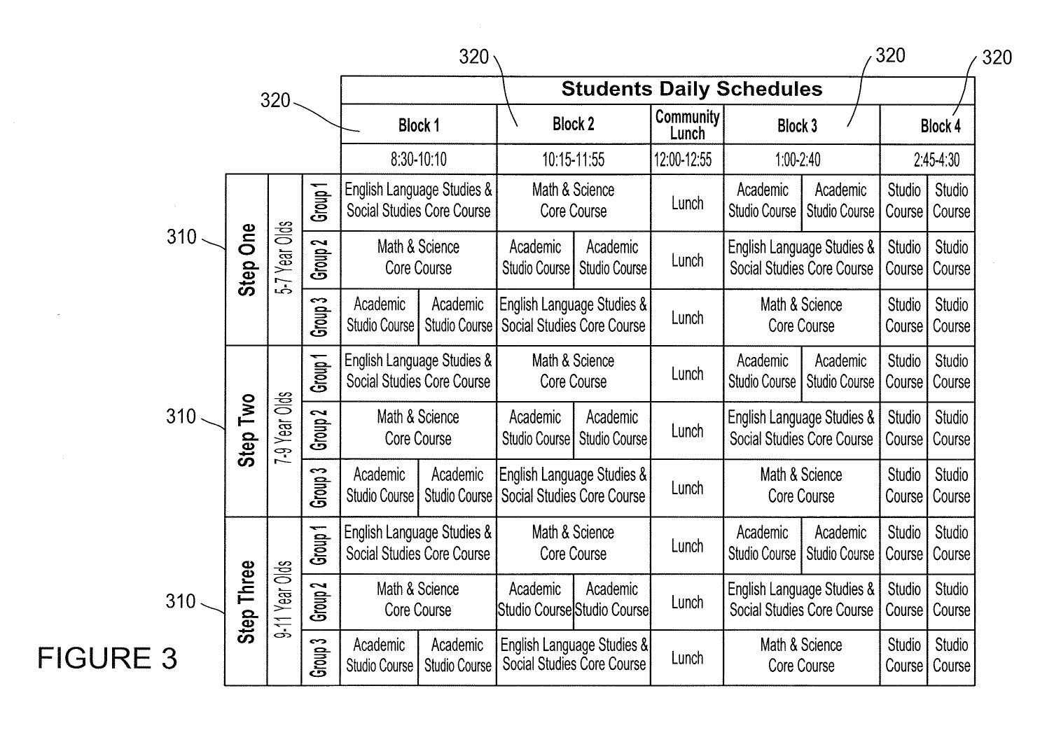

FIG. 3 is a chart illustrating the daily schedule of a student, according to various aspects of the invention. In addition to core Foundation courses 210, each child/student may participate daily in two to four Studio courses 220. According to various aspects of the current invention, these hands-on classes may cover many dynamic topics including art, athletics, world languages, dance, cooking, gardening, creative writing, filmmaking, geography, current events, technology, music, fitness, advanced sciences and technology, remediation or enrichment, counseling, and the like. These courses may vary in duration. Some Studio courses 220 may last a month, others a semester or more, which allows students to take many types of courses throughout the year and also enables the staff to plan courses that adapt to needs and interests of the students. The vast array of Studio courses 220 offers enrichment opportunities for public school children, where every student may have physical education together with art and music and academic enrichment every day. The variety and flexibility allows a school to more completely address the individual needs of students.

According to various aspects of the current invention, the students may be arranged into steps 310 instead of grades. Decisions about what step 310 a given student is in may be based primarily on the student's age, but would also take into consideration the student's academic, social and emotional needs. Students may take formal, required city, state and federally mandated tests appropriate for their age to determine which step 310 they would be assigned to.

According to various aspects of the current invention, teachers may strategically serve sensible dual roles. A plurality of teachers may teach at least one or more Foundation courses 210 in the morning followed by one or more Studio courses 220 in the afternoon. Other teachers may provide administrative support for a small portion of their morning and teach Studio courses 220. The Intensive Course teachers may provide non-teaching support, as part of a “Smart Start” initiative, during the first months of the school year as their dual-role responsibility. Aspects of the invention allow the school to concentrate its resources on the highest instructional priorities while still providing all of the services and administrative responsibilities expected of a school. As a result, the teachers serve dual roles, teaching at least one Foundation course 210 and one Studio course 220. Teachers may also be able to work with far fewer students for more time than in a conventional school. The invention allows also for teachers to have more common professional time with other teachers, during which time they can discuss their work, to know students and their needs, and plan for the success of individual students. Each student may attend two Foundation courses 210, each lasting, for example, 85 to 100 minutes long such as, for example, Humanities and Integrated Mathematics, each day. Each core course may be taught by a combination of teachers so that the class size remains between 14 and 20 students per teacher.

On the teacher's side, the teachers' schedule 190 in FIG. 1 may include morning sessions 180 and afternoon sessions 170 and 160. The morning sessions 180 may be dedicated to Foundation courses 210 as discussed above. The afternoon sessions 170 and 160 may be dedicated to Studio courses such as Studio course 170, but may also be dedicated to preparation and planning time. Accordingly, each teacher may devote up to 120 minutes of planning time each day, instead of the much lower amount of time traditionally provided teachers in traditional public schools. It should be noted that Studio courses 170 illustrated in FIG. 1 are equivalent to Studio courses 220 illustrated in FIG. 2.

According to various aspects of the current invention, Foundation course teachers may teach two Foundation courses 210 daily, teach one Studio course 220, and may have one block 320 illustrated in FIG. 3, which may be the time equivalent to one Studio course 220, for common work time with colleagues. The daily schedule provides opportunity for faculty collaboration. All of the lead teachers for a given course may have common planning time during the same block 320 every day. Graduate residents may also have common planning time weekly with their respective lead teachers.

According to various aspects of the current invention, once a year, twice a year or more, and for example for a month at a time, the students may participate in rigorous, credit-bearing Intensive courses modeled after intersession programs at colleges and universities. Built into an expanded 200-day school year, the courses may expand essential English and Math instruction. The Intensive Courses may be taught by a team of certified teachers and a guidance counselor who may rotate through each grade level throughout the year. During those Intensive Courses, the city becomes the classroom: students may explore a wide variety of college campuses, corporate boardrooms, community organizations, public service organizations, and the like. The Intensive Course class size may be smaller than a regular class, thus enabling the faculty to customize instruction and guidance for students and their families. The Intensive Courses change the concept of college guidance, preparing students with the academic skills and knowledge they need to be accepted into post-secondary education, and the life skills and experiences to succeed once there. The Intensive Courses program helps all students fully understand their options for the future, and motivates the students to achieve at their highest capacity.

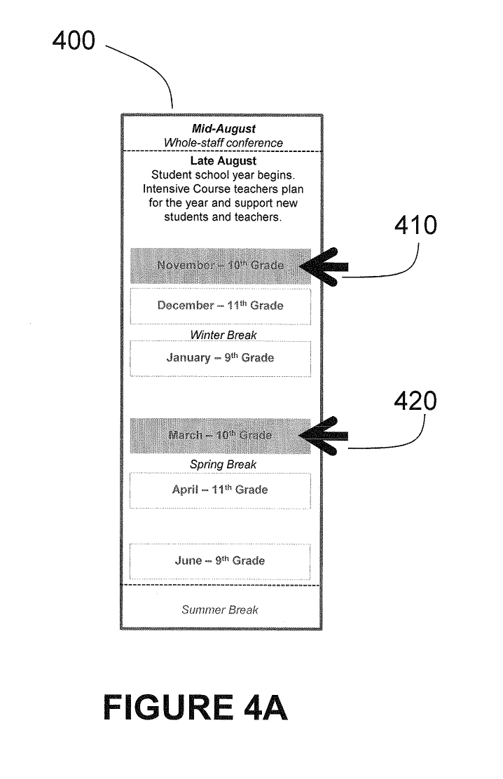

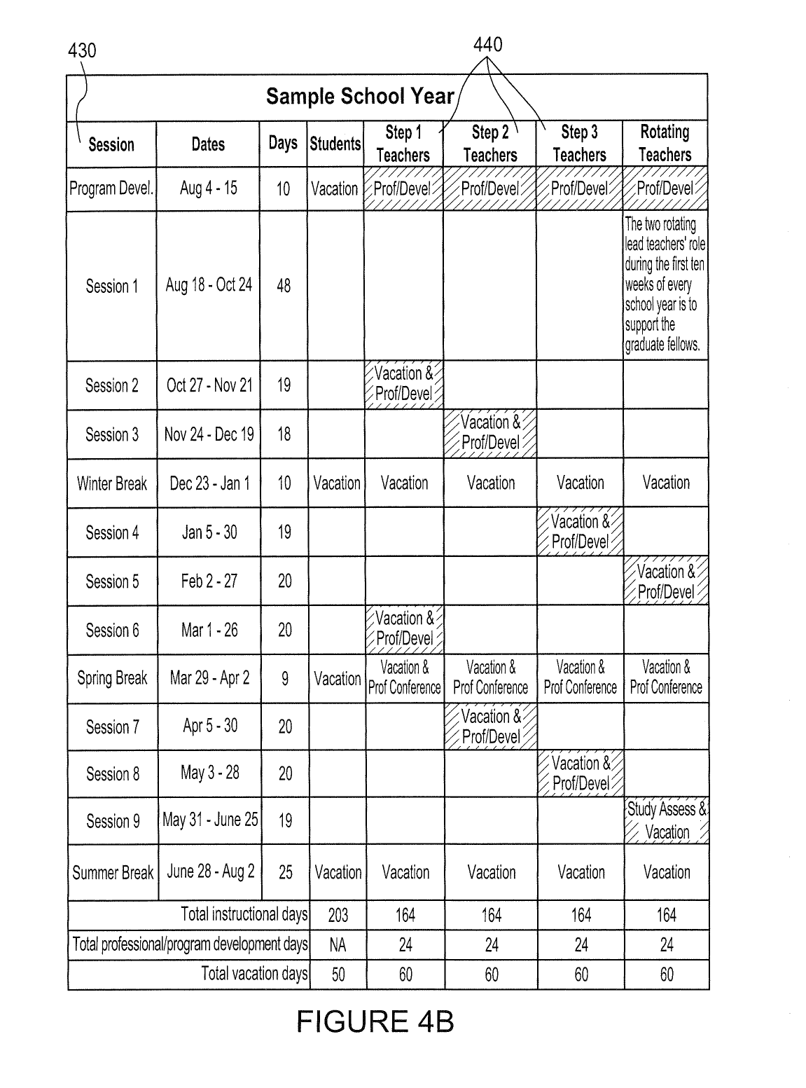

FIGS. 4A and 4B are charts illustrating an annual schedule 400 for improving the school year, according to various aspects of the current invention. According to various aspects of the current invention, compared to a typical school day and the traditional 180-day school year, aspects of the current invention offer a longer school day combined with an extended school year. This extended educational time may provide every student with up to 30% more instructional time each year without increasing the work year for teachers. This goal may be accomplished by using a team of rotating teachers who rotate from grade to grade, working with each grade for a period of time such as, for example, up to two months or more, staggered throughout an 11-month school year.

With respect to the annual calendar, according to various aspects of the current invention, the student year can be extended to over 200 school days, while each teacher's instructional year is actually decreased from about 180 days to about 160 days. This decrease in an individual teacher's instructional time provides the teacher with about four weeks of paid on-site staff and program development per year. Achieving this goal is possible because of the additional team of teachers who rotate through each grade throughout the school year. In addition to its faculty, each school according to various aspects may have a vital team of on-site program directors who ensure that the school is properly run and efficient. Furthermore, rotating teachers may spend a month with every class, for example, twice a year at 410 and 420. During these rotations, month-long, credit-bearing courses that may culminate in real-life projects may be given to students by a team of full time teachers. Also during these rotations, the remaining grade-level teachers may spend the time, for example, on professional development or on vacation.

According to various aspects of the current invention, the student instructional year can be further extended without increasing the teachers' work year by lengthening instructional days and shortening teachers' professional development days. By lengthening the instructional days, students benefit from longer instructional days during the year. By balancing the roughly 160 longer instructional days that teachers work with students with roughly 20 shorter professional development days, teachers work the same number of minutes over the course of the year as teachers in conventional schools.

Aspects of the current invention provide professional staff significantly more professional time to work with colleagues or engage in professional development led by colleagues, by the administration or by academic partners. By reconfiguring the school day, teachers have time each day with their content and grade level teams. They may have their shared time structured around best practices, for example, reviewing pacing calendars and unit, project and lesson plans, reviewing student work and a variety of forms of student data. By reconfiguring the teachers' work year, aspects of the current invention provide professional development time to grade-level teams of teachers while their students have intensive courses, and the academic staff may undertake professional development before the school year begin and during student vacations.

FIG. 4B is a chart illustrating a school year for faculty, according to various aspects of the current invention. The school year may be organized with respect to a plurality of sessions 430, where an individual session 430 may last a same or a different number of days than another session 430. According to various aspects, the school year may also be organized with respect to steps 440, which correspond to the steps 310 of FIG. 3, where the students may be arranged into steps 430 instead of grade levels.

FIG. 5 is a table illustrating a curriculum framework 500, according to various aspects of the current invention. According to various aspects of the current invention, Foundation courses 510 and Studio courses 520 may both culminate in a community presentation, project, activity or event that demonstrates mastery of course goals. In addition, students may take course culmination tests modeled after standardized assessments. By successfully achieving milestones for which they are responsible, students may practice meeting deadlines and maintaining high standards for themselves. For the faculty, the regularly scheduled milestones create school-wide transparent accountability and provide an incentive to keep up with the instructional goals of the curriculum framework. Courses that require more than a month to complete may still have interim benchmarks to complete as well as a culminating project.

According to various aspects of the current invention, course sequences and pacing calendars may be reconfigured to adjust for students needs, defining a longer instructional year, different mid-year breaks, smaller class sizes especially in Foundation and Intensive courses, and the opportunity for teachers to integrate technology in their classrooms. Unit plans, lesson plans and projects may be developed to fully take advantage of the opportunity to leverage time, talent, technology and relationships to address students' needs. For example, a teacher in a high school may reconfigure social studies and English language arts curriculum to create an integrated humanities course, may divide the curriculum into units based on the unique annual calendar, plan for students to complete projects that use the time and supports available in his or her Foundation course 210, and the like. Courses, assessments and accountability measures can be designed to build on conventional instructional methods, and maximize the effect of the talent, time, space and technology available to Foundation, Studio and Intensives teachers.

Aspects of the current invention include the potential for an innovative teacher training and induction program. Analogous to professional residencies in other fields, such as medicine, exceptional aspiring teachers may work side-by-side with veteran educators as they become confident and competent teachers themselves. Extensive on-site training and support to the residents as they earn a master's degree in teaching and dual certification in a content area and certification specifically for working, for example, with special education and/or English language learners. The degree may be provided in collaboration with an accredited university partner or as part of a program and accredited by the appropriate accrediting agent. During a multiyear residency, residents may serve vital yet sensible roles. Residents may fulfill important functions daily, and each resident may be a “home base” teacher for a small number of children such as, for example, eight children. The residents may support the faculty in core curriculum courses, including literacy and mathematics, and may teach an enrichment course to one or more small groups of students, as illustrated in FIG. 3B.

According to various aspects of the current invention, the faculty may be supported by residents as described above. Carefully selected from a national pool of highly qualified applicants, the residents may come from many walks of life. One residency goal may be, for example, to prepare teachers to work in urban schools. Participants in the residency may have to complete a comprehensive residency at the school while, for example, earning a master's degree and dual-certifications for teaching. Each school may provide, in collaboration with an accredited university partner or other qualified institution, extensive on-site training and support for each resident.

According to various aspects of the current invention, each graduate resident may fulfill several functions every day. They may support lead teachers in the core curriculum courses, they may teach a Studio course, and they may be home base teachers for a small number of children, such as, for example, about eight children. Accordingly, first-year graduate resident may attend a training seminar of several weeks during the summer prior to working at the school. A first-year graduate resident may be joined for a portion of the training seminar by second- and third-year resident, lead teachers and program directors. According to various aspects of the current invention, during each school year, graduate residents may have one or more week-long in-service training seminars with the lead teachers from their respective step, such as steps 310 of FIG. 3. The training seminars may address relevant issues and prepare each team of teachers for upcoming curriculum units. According to various aspects, each new graduate resident may be partnered with a peer mentor from the second- and third-year residents.

According to various aspects of the current invention, an ongoing support model assures that residents flourish throughout their multi-year experience at the school. For example, during the first few weeks of each school year, a responsibility of both rotating teachers may be to help the residents with their Studio courses. These teachers may guide fellows as they become confident in classroom management and organization, lesson planning, pedagogy and student assessment. According to various aspects, the fellows may work closely over time with the teachers of their respective steps, such as steps 310 of FIG. 3, learning from these experts in the field, and together, the fellows and their teachers actively reflect upon what they observe during meetings set aside weekly.

According to various aspects of the current invention, the school might include veteran lead teachers. These veteran teachers may be responsible for ensuring that every student excels in core learning areas, particularly, for example, in English Language Studies and/or Mathematics. Lead teachers may be recruited for their expertise in a core content area and for their experience with children at a specific developmental stage of the children's life. Exceptionally qualified with long histories of success, each teacher may be a content expert in their curricular field. Each teacher may have proven, successful classroom experience, and may be fully state certified, preferably with certification in special education.

According to various aspects of the current invention, veteran lead teachers may oversee core curricula and instruction in English language studies and math. They may develop effective authentic assessments for these courses and customize instructional strategies for students. The lead teachers may ensure that instruction has addressed curriculum standards required by the state.

According to various aspects of the current invention, teachers may stagger the assessment of students. For example, instead of writing report cards for the entire class at a time, the lead teachers may reflect upon and document the progress of a few students every week of the school year. Additionally, rotating teachers may spend a month with every class, for example, twice a year at 410 and 420 illustrated on FIG. 4A. During this time, the rotating teachers may conduct criterion-referenced standardized assessments and prepare students for statewide tests. Furthermore, since the rotating teachers work with each student each year the child is enrolled in the school, these teachers may also provide a long-term assessment of each child over time.

According to various aspects, every child may have a “home base” teacher, or advisory teacher, who may be one of the graduate residents, the home base teacher ensuring, for example, that the daily schedule of the child is going according to plan. For example, with only about ten to fourteen students per group, the home base teacher may provide a safety net for children and their families. For example, when a child is absent from school, the home base teacher determines the reasons for the child's absence and may interact with the child's family. If a child/student is having personal difficulties with another student, for example, the home base teacher may help the child find effective and respectful ways to work through the issues. Home base teachers may follow their students to core curriculum courses and may enjoy a community lunch with them. According to various aspects, the home base teachers may work with the same students and their families for several years, for example for up to three years.

According to various aspects of the current invention, the students receive significant support longitudinally, over time, as they progress through the grades or steps, such as steps 310 of FIG. 3. While the entire faculty may commit to the comprehensive academic success of each student, the rotating teachers may be responsible specifically for preparing every student for statewide standardized examinations, and students take the test appropriate for their age. The rotating teachers may be familiar with the testing strengths and needs of each student and may share data about individual students as well as about the school as a whole with the staff, thereby enabling the faculty to respond to what is learned. In order to support the development of ongoing and meaningful home/school relationships, students may work with the same teachers for multiple years instead of having a new teacher each year. Home base teachers may be partnered with the same students for a period of time longer than the school year, for, for example, up to three years. For example, the Foundation teachers may work with every student for at least two consecutive years.

According to various aspects of the current invention, the methods and systems of the current invention include bringing together a team of education professionals in order to achieve the above-discussed goals. For example, a plurality of teachers may work on grade level teams. Within the team, the teachers may have colleagues teaching the same or related Foundation course 210. The colleagues within this smaller team are able to use their common time to review course sequences, pacing calendars, unit plans, projects and student assessments. These teachers can be flexible with the grouping of students in the various sections of the same Foundation course 210 so as to more effectively address the students' academic, social and emotional needs. According to various aspects of the current invention, the team may include, for example, lead teachers, graduate residents, program directors and a support staff.

According to various aspects, the above-discussed staffing structure, which provides for the teaming of teachers, allows for highly flexible student grouping options on any given day. It may be that each teacher works generally with one group of students for a period of time—a week, unit or term. Depending upon the goals for a lesson or project, as well as learning styles and modalities of the different students, one teacher may, for example, work with the whole class, with small groups, or with an individual student. Meanwhile the graduate residents or other members of the teaching team concentrate on the rest of the class. Such focused teaching is generally difficult to achieve in traditional public schools where a single teacher has to work with all the students.

Aspects of the current invention provide teachers the opportunity to reconfigure curriculum as they prepare students for exit requirements and state mandated tests. Teachers may integrate disciplines, adjust course sequences and pacing calendars, and plan projects that ensure students not only can build essential skills in reading, writing, and math. Teachers may also integrate conventional whole class instructional methods, small group instruction and work with individual students, use technology in a blended model, and additional assessments and accountability methods. Teachers may develop twenty-first century workplace capacities as well, such as creativity and innovation, critical thinking, negotiating, communicating, facilitating, debating, problem solving, project managing, innovating, budgeting, information and media literacy, flexibility and adaptability and more.

Aspects of the current invention provide schools the opportunity to implement a Mission Accountability Plan (MAP) annually. The MAP may detail a qualitative and quantitative assessment of the past school year, and may articulate curricula, pedagogy, student assessment, special needs services and Studio courses for the upcoming year.

Various aspects of the current invention may include an additional team of teachers that may rotate to each of the grades throughout the year. The rotating teachers may create the opportunity to extend the school year for students by approximately one month without extending each teacher's work year.

According to various aspects of the current invention, Intensive Course teachers may work with students for a period of time, possibly more than once a year. For example, an intensive Course teacher may work with a student a month at a time, twice a year. An Intensive Course teacher may, for example, provide college and career counseling to high school students. For example, if a given student is interested in a career in the law, then the Intensive Course Teacher may plan the month to include reading, writing, research and project-based work related to the path the student might pursue from high school, through college, law school and into a legal career. The Intensive Course teacher may provide the students with one or more targeted classes dedicated to explaining various aspects of a career in the law as well as substantive material as to the subject matter of the law. The Intensive Courses may be different for elementary school classes and may include intensive experiences that are more project-based, such as expeditions, foreign language immersion programs, arts, on-site visits, and the like. The Intensive Course teachers may be separate from Foundation course and Studio course teachers, but may also be either one or both Foundation and Studio course teachers. The Intensive Course teachers may also be graduate residents.

Accordingly, each student may have an academically rigorous and individualized learning experience, decreasing the probability of a child failing out of the education system because a team of several teachers may serve a class of about 30 students, thus providing more personalized and engaging instruction for every student at all times. This staffing structure creates opportunities for every student to be actively engaged and continuously challenged during the entire daily sessions, all year long. As a result, about 85-minutes to 100-minutes of daily instruction may yield substantially better results for each child or student than the same amount of time in a traditional classroom setting where a single teacher must manage, motivate and instruct an entire classroom of diverse students.

As discussed above, in addition to core Foundation courses 210, each student may participate daily in two to four Studio courses 220. According to various aspects of the current invention, these hands-on classes may cover many dynamic topics including art, athletics, science, world languages, dance, cooking, gardening, creative writing, filmmaking, geography, current events, technology, and the like. These courses may vary in duration. Some Studio course may last a month, others a semester or more. The vast array of Studio courses offers enrichment opportunities for public school children, where every student may have physical education together with art and music and academic enrichment every day. FIG. 3 is a chart illustrating the daily schedule of a student, according to various aspects of the invention.

According to various aspects, the “home base” or advisory teachers may at times have lunch with their students. Modeled on programs at prestigious private schools, the community lunch provides advisors the opportunity to connect in less formal but meaningful ways with their students, and provides the opportunity for students to present their work, issues and resources to the wider school community. The community lunch may provide opportunities for the school to host guests and speakers, and allow the advisors to know students individually and support their academic, social and emotional growth over time.

According to various aspects of the current invention, the team of teachers and residents makes it possible to effectively incorporate critical multilingual services into the school in order to have students become proficient both in English and in their respective home languages when different from English. By recruiting teachers and residents who speak the languages of the school community, all families can be assured that a translator can help them stay connected to the school. Furthermore, the school can offer many world language Studio courses to all students.

According to various aspects of the current invention, at least a portion of the teachers may have special education credentials, which would make it possible to offer a truly inclusive classroom experience to all children with a wide range of individual learning needs. Mandated services may be incorporated into the core curriculum courses, with supplemental services scheduled during Studio course times. Special-needs screening processes may be managed by the Family and Community Partnerships Director.

According to various aspects of the current invention, staff of the school are able to address student needs comprehensively. Teachers can plan, assess and reflect on their teaching collaboratively every day; teachers on a team can co-teach whenever the need arises. Teachers can group and regroup students in their Foundation courses 210 nimbly so that students with special education or ELL needs are not segregated, tracked, or prevented from taking advantage of the full range of opportunities in the school. Unlike students in a conventional school, these students are not isolated to work with just a subset of teachers in the school, or isolated from the broader range and expertise of teachers.

According to various aspects of the current invention, students are able to earn and obtain credit for courses taken in more efficient and nimble ways. Longer Foundation courses 210 may allow students more time with core subjects. Studio courses can be planned for shorter timeframes and in response to students' remedial and enrichment needs to keep them on track for their Foundation courses 210, or catch them up if they begin to fall behind. Technology can be integrated into all of the classes to provide students with a different learning tool and resources to address their remedial or enrichment needs. Similarly, Intensive Courses may be taught by certified English teachers and may be designed to enable students to earn English credits as part of the curriculum.

According to various aspects, each teacher may have more than one hour per day for long-term planning and program development. This common planning time allows for the entire faculty to develop a unified curriculum and pedagogy that is seamless across each one of the various steps, such as steps 310 of FIG. 3, of the curriculum. The teachers may also create challenging interdisciplinary projects that have children excited about learning while ensuring that all students master the skills and knowledge they will need throughout their lives.

According to various aspects of the current invention, the school may include an executive director or principal, which may be the organizational and instructional leader of the school, and may work with the faculty to ensure that the mission of the school is being met and that the educational programs are rigorous and aligned with state standards. The executive director is the direct manager of program directors and the lead faculty. An accountability and development director may draft and submit any mandated reports to local, state and federal agencies and creates partnerships with research organizations to formally evaluate the school. A fulltime graduate resident may be assigned to support this director.

According to various aspects, a family and community partnerships director may ensure that families and the community are connected to the school and their voices are heard. This director may facilitate partnerships with community-based organizations, coordinate evening and weekend programming and promotes volunteerism. A human resource and graduate resident director, who would recruit and retain good lead teachers, program directors and graduate residents, may also be added to support the director. As such, there may be a fulltime school-based director specifically responsible for staff recruitment, selection and support. This director's duties may include recruitment of applicants, management of the selection process, coordination of the pre-service and on-site training and staff support throughout the school year. In terms of the residency program, this director is the school's liaison with the colleges, universities or other institutions that enroll our fellows.

According to various aspects of the current invention, a school wellness director may oversee school safety, health and nutrition planning. This director may manage staff, which includes guidance counselors, social workers and teachers who attend to students' physical, social and emotional health and programs. This director may manage the community lunch program and oversee the physical education Studio courses. The director may be responsible for developing relationships with companies and organizations focused on health-related issues, and may also manage the school's emergency preparedness planning. The wellness director, working with the guidance counselors, social workers and Intensives teachers, is able to address the college and career readiness needs of all students starting in middle if not elementary school. The staff is able to provide both intensive and longitudinal support for students. With more than a thousand hours of contact with each student in middle and high school, the staff can attend to students' academic, social, emotional, physical and creative needs.

According to various aspects of the current invention, a technology director may work closely with all of the directors and faculty to ensure that the school is leveraging technology effectively to meet its programmatic and financial responsibilities. The technology director may purchase, set up, and maintain equipment, and may train staff to use hardware and software. Other responsibilities may include developing and maintaining databases, websites and school archives and supporting staff in the development and use of organizational and pedagogic technology tools.

According to various aspects of the current invention, teacher roles and responsibilities may be differentiated more than in a conventional school, creating additional rungs on the professional ladder or a lattice of roles and responsibilities that would allow good teachers to develop their practice and support those newer to the profession. Less experienced teachers may be mentored by more veteran and more skilled teachers. Teachers with one certification may be able to work towards certification or an extension of their certification in a second content area, or to work with special education students or English language learners. Teachers who chose to be part of an administrative residency could use professional development time and mid-year breaks to work on projects with staff of their school and other schools to develop skills, capacities and the knowledge base to become effective administrators.

According to the various aspects of the current invention, the processes, tools and materials used to develop and implement the invention could be used by existing schools to adapt aspects of the invention. This might include but would not be limited to the use of tools, training and technical assistance around aspects of a school's program including staffing structures, schedules, planning and assessment tools, curriculum, marketing materials, teacher training materials, manuals, technical assistance guides, etc. The existing schools might reconfigure their existing resources or transform their existing program. Districts may use aspects of the current invention to turnaround failing schools as aligned with federal and state mandates for schools designated as “failing” or being in need of improvement.

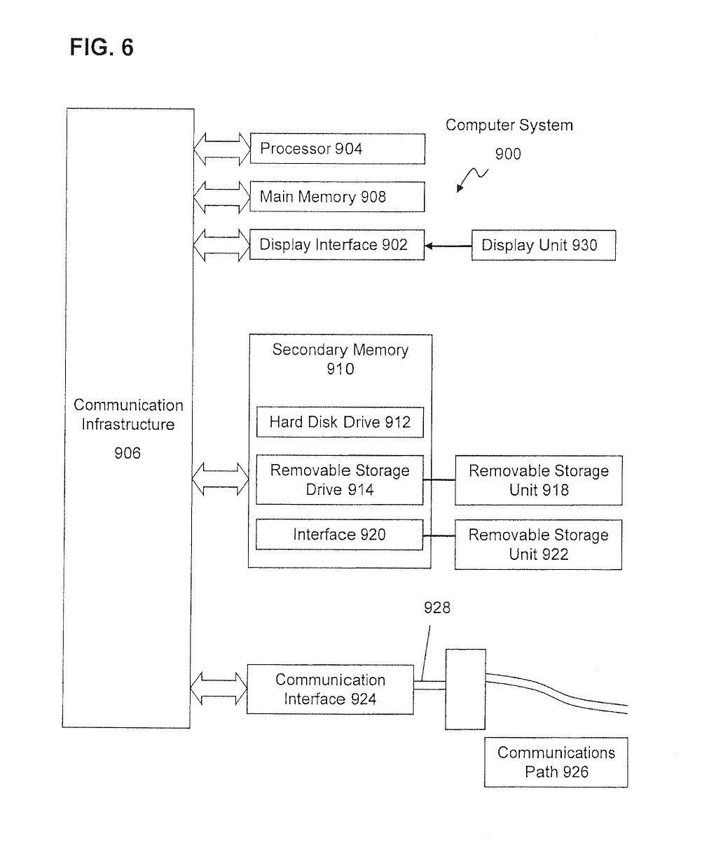

The above methods and systems may also be implemented using software and hardware components. FIG. 6 presents an exemplary system diagram of various hardware components and other features, for use in accordance with an aspect of the present invention. The present invention may be implemented using hardware, software, or a combination thereof and may be implemented in one or more computer systems or other processing systems. In one aspect, the invention is directed toward one or more computer systems capable of carrying out the functionality described herein. An example of such a computer system 900 is shown in FIG. 6.

Computer system 900 includes one or more processors, such as processor 904. The processor 904 is connected to a communication infrastructure 906 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an aspect where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

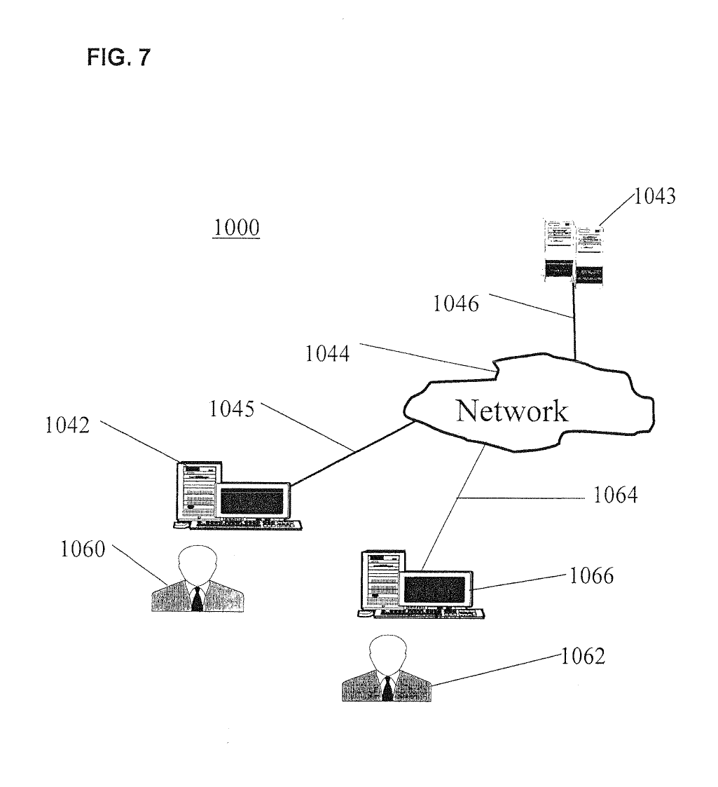

FIG. 7 is a block diagram of various exemplary system components, in accordance with an aspect of the present invention. FIG. 7 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060 and 1062 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046 and 1064 may include, for example, wired, wireless, or fiber-optic links. In another aspect, the method and system of the present invention operate in a stand-alone environment, such as on a single terminal.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method of organizing a study day for a plurality of students during a school year, the method comprising:
dividing the study day in a first study portion and a second study portion;
receiving at least one foundation course during the first study portion; and
receiving at least one studio course during the second study portion; wherein
the at least one foundation course comprises one of math, sciences, humanities, social studies, and English language studies; and
the at least one studio course is received during a variable number of days.

2. The method of claim 1, wherein:
the at least one studio course is chosen based on a need of a group of the plurality of students; and
the at least one studio course changes throughout a school year based on the need of the group of the plurality of students.

3. The method of claim 1, further comprising receiving one or more intensive course for a pre-defined period of time once or more than once during the school year.

4. The method of claim 1, wherein the first study portion comprises two foundation courses and the second study portion comprises one or more studio course.

5. The method of claim 1, wherein the at least one foundation course is 85 to 100 minutes long and each studio course is 60 to 72 minutes long.

6. The method of claim 1, wherein the first study portion is a morning session and the second study portion is an afternoon session.

7. A method of organizing a teaching day for a plurality of teachers during a school year, the method comprising:
dividing the teaching day in a first teaching portion and a second teaching portion;
providing at least one foundation course during the first teaching portion by one or more of the plurality of teachers; and
providing at least one studio course during the second teaching portion by one or more of the plurality of teachers; wherein
the at least one foundation course comprises one of math, sciences, humanities, social studies, and English language studies; and
the at least one studio course is provided during a variable number of days.

8. The method of claim 7, wherein the at least one studio course comprises a session for planning and preparation.

9. The method of claim 7, further comprising providing one or more intensive course for a pre-defined period of time once or more than once during the school year.

10. The method of claim 9, wherein the plurality of teachers are on grade level teams that comprise at least one lead teacher, at least one other teacher, and at least one resident.

11. The method of claim 10, wherein the at least one resident is trained to teach the at least one foundation course and one studio course or the one or more intensive course.

12. The method of claim 9, wherein the one or more intensive course comprise at least one of courses, seminars, visits and projects related to college or professional aspirations of a student.

13. The method of claim 10, wherein:
the at least one lead teacher teaches the at least one foundation course;
the at least one studio teacher teaches the at least one studio course; and
one or more of the lead teacher, the studio teacher and the resident teaches the at least one intensive course.

14. The method of claim 7, wherein the at least one foundation course and the at least one studio course are taught by a same teacher.

15. The method of claim 1, wherein an average class size for the at least one foundation course is smaller than an average class size for the at least one studio course.

16. The method of claim 1, wherein the one or more steps of students encompass one or more age ranges each.

17. The method of claim 10, wherein the at least one resident:
serves as a home base teacher to a set of students; and
supports the at least one lead teacher and the at least one studio teacher; wherein the home base teacher at least one of:
maintains close contact with a family of each student from the set of students to provide an environment conducive to education;
helps each student from the set of students resolve disputes with other students or with teachers; and
works with a same set of students for a plurality of years.

18. A method of organizing a schedule for grade level teachers, rotating teachers and one or more sets of students during a school year, the method comprising:
assigning one or more of the grade level teachers to a set of students, wherein the students within the set belong to a same age range;
providing grade level teachers with periods of professional development during the school year; and
assigning one or more of the rotating teachers to the one or more sets of students, wherein the one or more rotating teachers are assigned to a given set of students when the permanent teacher of the given set is unavailable;
wherein a total number of instructional days for each student in a school year is greater than a total numbers of instructional days for each teacher in the school year.

19. The method of claim 18, wherein the professional development comprises at least one of a daily period of time for collaborative work, grade-level conferences and seminars, school-level and school network-level conferences, and continuing education.

20. A system for organizing a teaching day for a plurality of foundation course teachers and studio course teachers, the system comprising:
means for dividing the teaching day in a first teaching portion and a second teaching portion;
means for providing at least one foundation course during the first teaching portion by one or more of the plurality of teachers; and
means for providing at least one studio course during the second teaching portion by one or more of the plurality of teachers; wherein
the at least one foundation course comprises at least one of math, sciences, humanities, social studies, and English language studies; and
the at least one studio course is provided during a variable number of days.

21. A system for organizing a schedule for grade level teachers, rotating teachers and one or more sets of students during a school year, the system comprising:
means for assigning one or more of the grade level teachers to a set of students, wherein the students within the set belong to a same age range;
means for providing grade level teachers with periods of professional development during the school year; and
means for assigning one or more of the rotating teachers to one or more sets of students, wherein the one or more rotating teachers are assigned to a given set of students when the permanent teacher of the given set is unavailable;
wherein a total number of instructional days for each student in a school year is greater than a total numbers of instructional days for each teacher in the school year.

22. A system for organizing a study day for a plurality of students, the system comprising:
means for dividing the study day in a first study portion and a second study portion;
means for receiving at least one foundation course during the first study portion; and
means for receiving at least one studio course during the second study portion; wherein
the at least one foundation course comprises at least one of math, sciences, humanities, social studies, and English language studies; and
the at least one studio course is provided during a variable number of days.

23. The system of claim 22, further comprising:
means for receiving at least one intensive course for a pre-defined period of time once or more than once during the school year.

24. The system of claim 20, further comprising:
means for providing at least one intensive course for a pre-defined period of time once or more than once during the school year.
